(19) United States
(12) Patent Application Publication
(10) Pub. No.: US 2024/0012400 A1
(43) Pub. Date: Jan. 11, 2024

(54) FAILURE PREDICTION IN SURFACE TREATMENT PROCESSES USING ARTIFICIAL INTELLIGENCE

(71) Applicant: Siemens Corporation, Washington, DC (US)

(72) Inventors: Shashank Tamaskar, Mohali, Punjab (IN); Martin Sehr, Kensington, CA (US); Eugen Solowjow, Berkeley, CA (US); Wei Xi Xia, Daly City, CA (US); Juan L. Aparicio Ojea, Moraga, CA (US); Ines Ugalde Diaz, Redwood City, CA (US)

(73) Assignee: Siemens Corporation, Washington, DC (US)

(21) Appl. No.: 18/041,718

(22) PCT Filed: Aug. 28, 2020
(86) PCT No.: PCT/US2020/048315

§ 371 Date: Feb. 15, 2023

(51) Int. Cl. G05B 19/418

(52) U.S. Cl. CPC G05B 19/41875; G05B 2219/32193

(57) ABSTRACT

A computer-implemented method for failure classification of a surface treatment process includes receiving one or more process parameters that influence one or more failure modes of the surface treatment process and receiving sensor data pertaining to measurement of one or more process states pertaining to the surface treatment process. The method includes processing the received one or more process parameters and the sensor data by a machine learning model deployed on an edge computing device controlling the surface treatment process to generate an output indicating, in real-time, a probability of process failure via the one or more failure modes. The machine learning model is trained on a supervised learning regime based on process data and failure classification labels obtained from physics simulations of the surface treatment process in combination with historical data pertaining to the surface treatment process.

### STATEMENT REGARDING FEDERALLY SPONSORED DEVELOPMENT

Development for this invention was supported in part by Subaward Agreement No: ARM-TEC-18-01-F-21, awarded by the Advanced Robotics for Manufacturing Institute (ARM) that operates under Technology Investment Agreement Number W911NF-17-3-0004 from the U.S. Army Contracting Command. Accordingly, the United States Government may have certain rights in this invention.

### TECHNICAL FIELD

The present disclosure relates generally to the field of failure prediction in surface treatment processes.

### BACKGROUND

A wide array of surface treatment processes is deployed across industries for parts of various sizes, geometries and materials. These surface treatment processes involve energy and/or material deposition to a workpiece and may require highly specialized equipment Examples of these surface treatment processes include direct energy deposition of metal, electron beam metal deposition, polymer based additive manufacturing, among others. A problem of the industry today is that these processes require precise calibration of process parameters (such as deposition rate, speed of the deposition head, temperature of the deposits and the base temperature) to prevent overheating of the part and to prevent temperature gradients, which can in turn lead to residual stresses. These residual stresses may lead to part degradation and defects.

### SUMMARY

Briefly, aspects of the present disclosure pertain to a technique for real-time prediction of one or more modes of failure in a surface treatment process using an artificial intelligence algorithm deployed on an edge device.

A first aspect of the disclosure sets forth a computer-implemented method for failure classification of a surface treatment process. The method comprises receiving one or more process parameters that influence one or more failure modes of the surface treatment process. The method also comprises receiving sensor data pertaining to measurement of one or more process states pertaining to the surface treatment process. The method comprises processing the received one or more process parameters and the sensor data by a machine learning model deployed on an edge computing device controlling the surface treatment process to generate an output indicating, in real-time, a probability of process failure via the one or more failure modes. The machine learning model is trained on a supervised learning regime based on process data and failure classification labels obtained from physics simulations of the surface treatment process in combination with historical data pertaining to the surface treatment process.

A second aspect of the disclosure sets forth a system for failure classification of a surface treatment process. The system comprises a sensor module configured to generate sensor data pertaining to measurement of one or more process states pertaining to the surface treatment process. The system further comprises an edge computing device for controlling the surface treatment process. The edge computing device is configured to process a machine learning model which receives, as input, one or more process parameters of the surface treatment process that influence one or more failure modes and the sensor data obtained by measurements during the surface treatment process, to generate an output indicating, in real-time, a probability of process failure via the one or more failure modes. The machine learning model is trained on a supervised learning regime based on process data and failure classification labels obtained from physics simulations of the surface treatment process in combination with historical data pertaining to the surface treatment process.

Other aspects of the present disclosure implement features of the above-described method in computing systems and computer program products.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1A and FIG. 1B respectively illustrate a warping defect and a delamination defect in a surface treatment process.

FIG. 2 is a schematic representation of a failure prediction software according to an aspect of the disclosure.

FIG. 3 is a schematic illustration of an exemplary system according an aspect of the disclosure.

FIG. 4 illustrates training of a neural network based on simulated experiences.

FIG. 5 illustrates calibration of a simulation trained neural network using historical data.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

The term “surface treatment process,” as used in this specification, refers to a process that involves energy and/or material deposition to build or modify a part. The energy may be applied, for example, in the form of a laser beam or an electron beam. The material may be metallic or non-metallic (such as polymers).

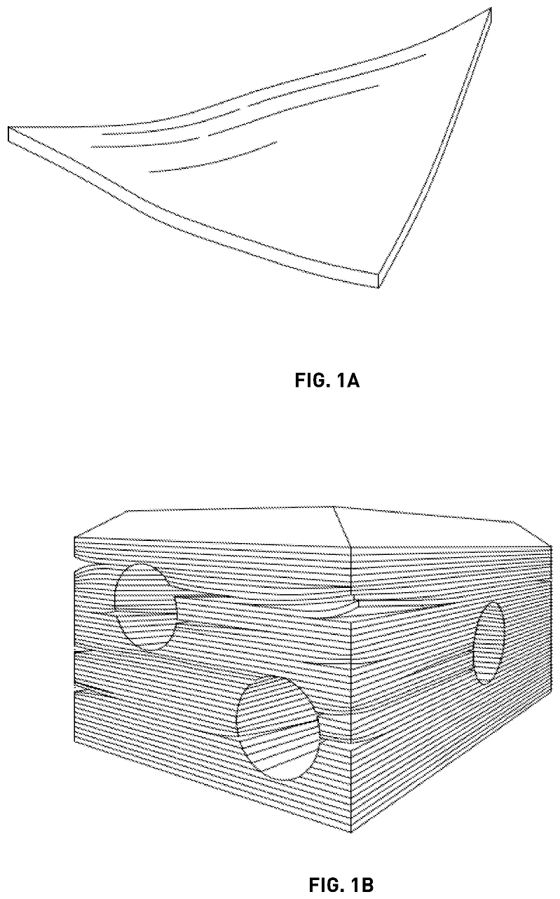

Many representative surface treatment processes, such as direct energy deposition of metal, electron beam metal deposition, polymer based additive manufacturing, etc., require specific temperature/process speed thresholds to be maintained to prevent defective parts. In order to reduce undesirable derivative effects from energy deposition, it is of importance to control precisely the process speed, temperature and stress distributions within manufactured parts so that defects can be prevented. FIG. 1A and FIG. 1B illustrate exemplary defects in surface treatment processes, such as warping and delamination, respectively. However, controlling thermomechanical parameters of the manufactured part is a challenging task. For most surface treatment processes, there exist no commercially available technical solutions that would provide precise process parameters to control thermomechanical parameters of the manufactured part. Large parts, parts with complicated geometric features and parts comprising of high-value, non-standard materials, such as those used in the aerospace industry, are particularly challenging. In the absence of good technical solutions, users have to conduct multiple trials with different process parameters to identify an acceptable solution.

The state of the art includes techniques for modeling of various surface treatment processes. For example, Megahed et al. (Megahed, M., Mindt, H. W., N'Dri, N., Duan, H., & Desmaison, O. (2016). Metal additive-manufacturing process and residual stress modeling. Integrating Materials and Manufacturing Innovation, 5(1), 61-93.) provide an overview of different techniques for modeling residual stresses in additive manufacturing. Similarly, Denlinger et al. (Denlinger, Erik R, Jarred C. Heigel, and Panagiotis Michaleris. “Residual stress and distortion modeling of electron beam direct manufacturing Ti-6Al-4V.” Proceedings of the Institution of Mechanical Engineers, Part B: Journal of Engineering Manufacture 229.10 (2015): 1803-1813.) describe failure modeling approaches in electron beam deposition. These techniques enable researchers to model the processes in a simulation environment and infer the relationship between the process parameters and failures. Some of the key challenges with these modeling techniques are: 1) relationship between process parameters and failures is highly nonlinear and it is difficult to model all the physical effects accurately; 2) these models require high fidelity multi-physics simulations which can require huge compute resources; 3) it is difficult to combine these results with historical experimental data about the real process.

Recently, deep learning techniques have been used for addressing the problem of modeling complex nonlinear relationship. For example, see Francis et al. (Francis, J., & Bian, L. (2019). Deep Learning for Distortion Prediction in Laser-Based Additive Manufacturing using Big Data. Manufacturing Letters, 20, 10-14.). While these techniques are well suited to model complex relationships, they require extensive training data and dedicated hardware which limit their applicability in manufacturing environment.

Using state of the art techniques, users may still have to resort to a combination of offline process modeling and extensive experimentation to achieve an acceptable solution.

Aspects of the present disclosure aim to simplify the user calibration effort and address the solution of real-time monitoring and failure prediction for surface treatment processes while not requiring a large amount of experimental data. The disclosed embodiments employ an artificial intelligence (AI) based algorithm, which may be run on edge computing hardware, that analyzes process parameters and process states of the manufactured part in real-time to predict a probability of process failure. Here, failure is defined as presence of part defects, which can occur via one or more failure modes, such as warping, delamination, cracks, among others. The AI algorithm is trained using a combination of simulation and experimental data. This enables reduction in amount of training data and also allows the system to be calibrated to a particular experimental setup.

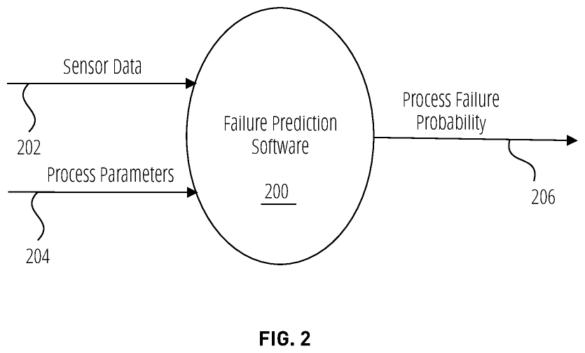

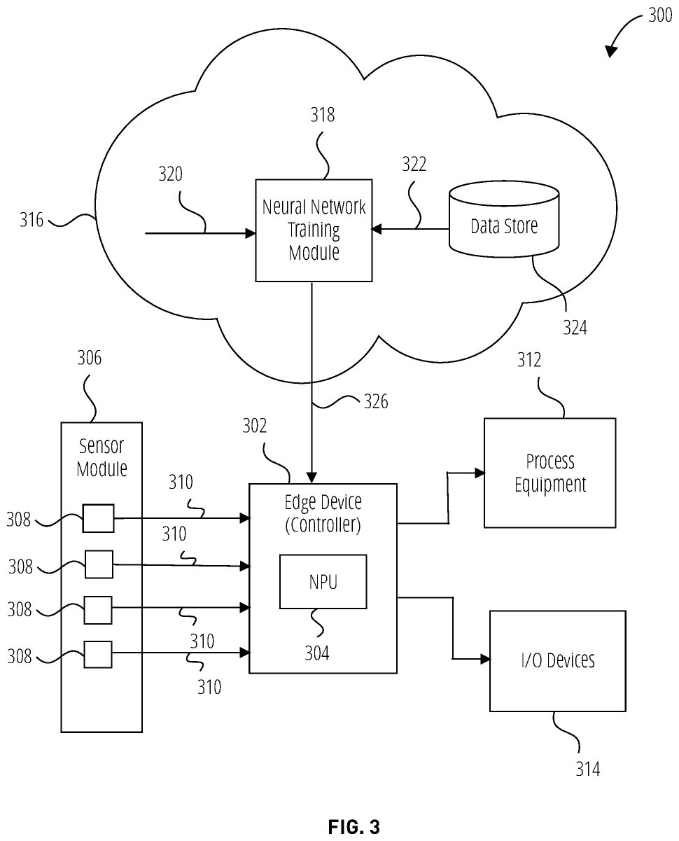

FIG. 2 schematically represents a failure prediction software 200 according to an aspect of the present disclosure. The failure prediction software 200 incorporates a trained machine learning model such as an artificial neural network, that receives, as input, sensor data 202 pertaining to measurement of one or more process states pertaining to the surface treatment process, as well as one or more process parameters 204. Based on the received input 202, 204, the machine learning model generates an output 206 indicating, in real-time, a probability of process failure via one or more failure modes. Prior to deployment, the machine learning model is trained using a supervised learning method based on process data and failure classification labels obtained from physics simulations of the surface treatment process in combination with historical data pertaining to the surface treatment process. The proposed failure prediction software 200 is computationally efficient, which enables it to be deployed on an edge computing device proximate to the surface treatment process, to ensure real-time operation, as shown in FIG. 3. In one embodiment, the proposed failure prediction software 200 may be deployed as a prognostic and health monitoring application and may work in coordination with edge AI hardware to provide real-time prognostics of the surface treatment process.

The one or more process states may include a material state of the part being built or modified by the surface treatment process. The material state may be measured by measuring a thermomechanical parameter of the part being manufactured at discrete time steps during the surface treatment process. In the present embodiment, the thermomechanical parameters considered are stress and temperature of the part. In particular, the sensor data may be indicative of a stress distribution and/or a temperature distribution in the manufactured part, for example, over a defined surface area or volume of the part. The temperature distribution may be measured by employing one or more infrared cameras, pyrometers, or other types of temperature sensors. The stress distribution may be measured, for example, by one or more acoustic emission sensors, accelerometers (e.g., piezoelectric sensors), among other types of stress sensors. The present inventors recognize that, in particular, a time-varying evolution of the temperature distribution and stress distribution within the manufactured part is highly predictive of process failure. Accordingly, in one embodiment, the sensor data pertaining to the material state (e.g., temperature and/or stress distribution) is processed by the machine learning model as series data including a measurement at a current time step and measurements at proceeding time steps during the surface treatment process.

The one or more process states may also include an environmental state (e.g., ambient temperature) pertaining to the surface treatment process. The environmental state may be measured statically or may be monitored dynamically during the process via respective sensors.

The process parameters include parameter settings that influence the material states of the manufactured part, and as such, the quality of the finished product. Process parameters may be adjusted, either dynamically or statically, to calibrate the surface treatment process. A typical surface treatment process may involve a very large number of process parameters, such as power (e.g., laser power or electron beam power), speed of the deposition head, temperature of the deposited material, tool path, part geometry, part orientation, layer thickness, hatching strategy, and so on. The failure prediction software 200 may be designed to utilize only a subset of these process parameters, to include the most important parameters that influence the defined failure modes. In the illustrated example, which is non-limiting, the process parameters utilized by the failure prediction software 200 include tool path, speed of deposition head and temperature of deposited material.

The output 206 of the machine learning model may indicate a probability of failure of each failure mode out of a defined set of one or more failure modes. For example, for n defined failure modes, the output 206 may indicate: probability of occurrence of failure mode 1, probability of occurrence of failure mode 2, . . . , probability of occurrence of failure mode n. In the illustrated example, which is non-limiting, the set of failure modes include warping, delamination and crack formation.

In one embodiment, the machine learning model comprises a deep recurrent neural network (RNN). Deep RNNs are designed to take a series input vector with no predetermined limit on size, which make them particularly suited to data with temporal structure, such as the series sensor data input described above. Moreover, deep RNNs are capable of processing high-dimensional input data in classification settings. In alternate embodiments, various other deep learning methods may be used, for example but not limited to, logic regression, convolutional neural networks (CNN), multi-layer perception (MLP) and support vector machines (SVM). These models can further be used in conjunction with physics-based models (comprising of differential or partial differential equations).

FIG. 3 illustrates a system 300 for real-time failure classification in a surface treatment process according to an example embodiment.

The system 300 includes an edge computing device 302, such as a process controller, where the proposed failure prediction software may be deployed. The edge computing device 302 may include, for example, a programmable logic controller (PLC) or any other type of industrial controller. In one embodiment, the industrial controller may be provided with one or more neural processing unit (NPU) modules 304. An NPU module 304 comprises dedicated edge AI hardware which may be custom designed to run the machine learning model in a computationally efficient fashion. The modular approach allows that the number of NPU modules 304 used may be determined based on the computational requirement of the specific application. A non-limiting example of an NPU module 304 suitable for the present application is the SIMATIC S7-1500 TM NPU™ manufactured by Siemens AG.

The system 300 further comprises a sensor module 306 comprising a plurality of sensors 308. The sensors 308 may include one or more temperature sensors, such as, infrared cameras, pyrometers, among others, and one or more stress sensors, such as acoustic emission sensors, accelerometers, among others. The sensors 308 communicate signals 310 comprising sensor data to the edge computing device 302 at discrete time steps during the surface treatment process. As described above, the sensor data pertains to measurement of one or more current material states of a part being built or modified by the process, such as a temperature distribution and/or a stress distribution within the part. The sensor module 306 may also include one or more sensors 308 for measuring the process parameters in real-time and communicating the measurements to the edge computing device 302.

The edge computing device 302 may be connected to process equipment 312, which may include equipment for controlling process parameters, such as power, speed, tool path, material temperature, and so on. In one embodiment, the edge computing device 302 may be configured to control the process equipment 312 to dynamically adjust one or more process parameters when the probability of process failure via the one or more failure modes in the output of the machine learning model exceeds a threshold value. A process failure via one of the failure modes may be thereby avoided. In another embodiment, the edge computing device 302 may be programmed to stop the surface treatment process or output a warning notification, when the probability of process failure via the one or more failure modes in the output of the machine learning model exceeds a threshold value. This allows a user to statically adjust one or more process parameters to avert a process failure. The warning notification may comprise, for example, an audible alarm, a visible indicator such as a flashing light, a display message, or combinations thereof. To this end, the edge computing device 302 may be connected to any number of suitable I/O devices 314.

In one embodiment, as shown in FIG. 3, the edge computing device 302 may receive a trained machine learning model (e.g., a neural network) from a remote computing environment, such as a cloud 316. This moves the computationally heavy training process away from the edge hardware, thus allowing a power-efficient, low-weight and small form-factor industrial controller to be used, which provides robustness in an industrial environment. The cloud computing environment includes a training module 318, which may involve hardware having high computational capability, such as a graphics processing unit (GPU). The training module 318 uses an untrained or skeleton neural network model 320 (i.e., with unadjusted weights) and data 322 from a data store 324 to generate a trained neural network 326, which may be subsequently deployed to the edge computing device 302.

As mentioned above, prior to deployment, the neural network is trained in a supervised learning regime, which requires data with associated classification labels. For this purpose, the present disclosure uses a combination of data obtained simulation experiences and data obtained from real-world (i.e., historical data of the surface treatment process). This allows the neural network to be trained and calibrated with fewer experimental data than the state-of-the-art techniques. In the embodiment described here, the training of the neural network comprises a first phase, namely a baseline training phase, followed by a second phase, namely a calibration phase. The baseline phase is based on process data and failure classification labels rendered by physics simulations executed on a plurality of generated process scenarios. The calibration phase comprises a re-training of the neural network based on process data and failure classification labels obtained from historical data pertaining to the surface treatment process.

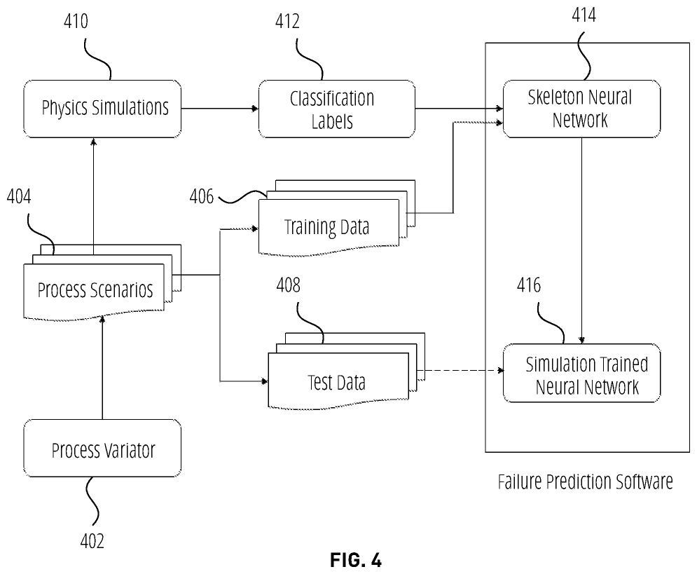

FIG. 4 illustrates the first phase of the training of a neural network according to the illustrated embodiment In this phase, a process variator 402 is utilized to generate a plurality of process scenarios 404 involving a set of one or more process parameters that are determined to be predictive of process failure via one of the defined failure modes. In the illustrated embodiments, those process parameters are tool path, speed of deposition head, temperature of deposited material. The process variator 402 may use a design of experiments methodology, such as a full factorial or a fractional factorial design, among others, to generate the process scenarios 404 across a sufficiently broad range of process parameter settings. Each generated process scenario 404 represents a unique combination of process parameter settings. The generated process scenarios 404 constitute process data used for training a skeleton neural network 414. A first portion of the generated process scenarios 404 may be used as training data 406 (with labels) in the supervised learning process while a second portion of the generated process scenarios 404 may be used as test data 408 (without labels).

After the process scenarios are generated, a physics simulation 410 is carried out on each generated process scenario to render a simulated experience for that process scenario. This may involve the use of a high-fidelity simulator, one suitable example of which is StarCCM+™ developed by Siemens PLM Software. It is to be noted that high-fidelity simulators in the context of the illustrated embodiment are used for training of the neural network and are not required at system run-time, meaning that computational efficiency after deployment will not be compromised by these tools. Similarly, these advanced tools enable capability to induce very targeted variations desired in the training data, so that rare domain-specific effects are captured reliably.

The physics simulations 410 are used to generate failure classification labels 412. The failure classification labels 412 are tagged to each process scenario in the training data 406. Each failure classification label 412 may include a binary variable (such as “failed” and “not failed”) associated with each failure mode in a set of defined failure modes. In some embodiments, a failure classification label 412 may include a continuous variable for one or more of the failure modes (e.g., percentage of warping). In yet another embodiment, a failure classification label 412 may include a label ranking, where the failure modes are ranked, for example, based on a method of pair-wise preference. The training data 406 and the tagged failure classification labels 412 are utilized for training the skeleton neural network 414 in a supervised learning regime. The physics simulations 410 may also be used to generate temporal series data pertaining temperature and stress distribution within the manufactured part, which may also be input as training data.

The supervised training regime involves repeated adjustments of parameters (weights, biases) of the neural network via back propagation utilizing the training data 406 and the associated failure classification labels 412. After the completion of the supervised learning, the resultant simulation trained neural network 416 may be tested based on the test data 408. Testing the simulation trained neural network 416 may be done to identify overfitting of the neural network. If overfitting is identified, it may be corrected for example, by data augmentation around underperforming data points, or by generating additional process scenarios to be used as training data for supervised learning again, among other methods.

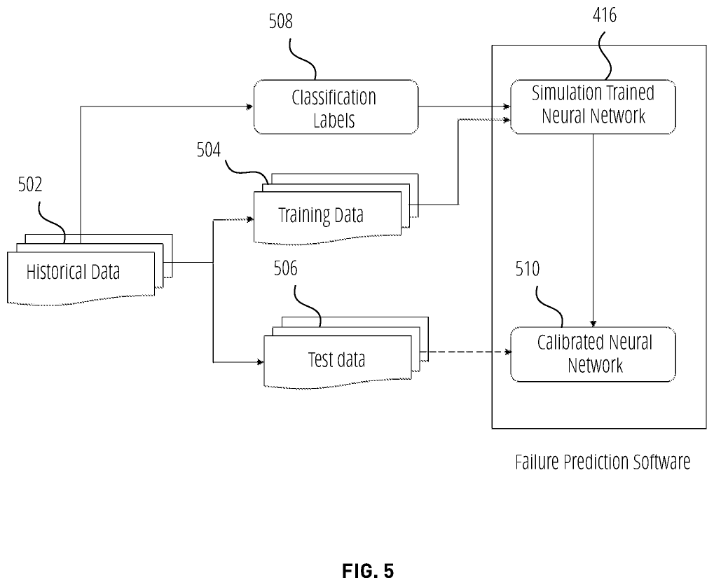

While high-fidelity simulators work reasonably well with thermomechanical surface treatment process data, a calibration phase may be desirable to bridge the gap between simulation and reality. As shown in FIG. 5, the calibration phase involves a re-training of the simulation trained neural network 416 using historical data 502. The historical data 502 may be obtained, for example by actual experimentation. In one embodiment, the experiments may be carried out by generating process scenarios using a design of experiments methodology as described above. In general, the historical data 502 may include data obtained from previous runs of the surface treatment process (e.g., using the same process equipment) based on a range of process scenarios, which may or may not be designed as an experiment. The historical data 502 constitute process data used for re-training the simulation trained neural network 416. A first portion of the historical data 502 may be used as training data 504 (with labels) in a supervised learning process and optionally, a second portion of the historical data 502 may be used as test data 506 (without labels).

Failure classification labels 508 may be extracted from the historical data 502. The failure classification labels 508 are tagged to each unit of the training data 504. As described above, each extracted failure classification label 502 may include a binary variable or a continuous variable associated with each failure mode in the set of defined failure modes. The training data 504 and the tagged failure classification labels 508 are utilized for re-training the simulation trained neural network 416 in a supervised learning regime. The neural network parameters (weights, biases) are thereby fine-tuned or calibrated using real-world data. After the completion of the supervised learning, a calibrated neural network 510 is obtained, which may be tested based on the test data 506 (for example to identify and correct overfitting of the neural network) before deployment to the edge computing hardware.

The embodiments of the present disclosure may be implemented with any combination of hardware and software. In addition, the embodiments of the present disclosure may be included in an article of manufacture (e.g., one or more computer program products) having, for example, a non-transitory computer-readable storage medium. The computer readable storage medium has embodied therein, for instance, computer readable program instructions for providing and facilitating the mechanisms of the embodiments of the present disclosure. The article of manufacture can be included as part of a computer system or sold separately.

The computer readable storage medium can include a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Computer readable program instructions described herein can be downloaded to respective computing/processing devices from a computer readable storage medium or to an external computer or external storage device via a network, for example, the Internet, a local area network, a wide area network and/or a wireless network.

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

1. A computer-implemented method for failure classification of a surface treatment process, comprising:
receiving one or more process parameters that influence one or more failure modes of the surface treatment process,
receiving sensor data pertaining to measurement of one or more process states pertaining to the surface treatment process,
processing the received one or more process parameters and the sensor data by a machine learning model deployed on an edge computing device controlling the surface treatment process to generate an output indicating, in real-time, a probability of process failure via the one or more failure modes,
wherein the machine learning model is trained on a supervised learning regime based on process data and failure classification labels obtained from physics simulations of the surface treatment process in combination with historical data pertaining to the surface treatment process.

2. The method according to claim 1, wherein the one or more process parameters include tool path, speed of deposition head, temperature of deposited material, or combinations thereof.

3. The method according to claim 1, wherein the one or more process states comprises a material state of a part being built or modified by the surface treatment process.

4. The method according to claim 3, wherein the sensor data pertaining to the material state is processed as series data including a measurement at a current time step and measurements at proceeding time steps during the surface treatment process.

5. The method according to claim 4, wherein the machine learning model comprises a recurrent neural network.

6. The method according to claim 3, wherein the material state includes a stress distribution and/or temperature distribution in the part being built or modified by the surface treatment process.

7. The method according to claim 3, wherein the one or more process states further comprises an environmental state pertaining to the surface treatment process.

8. The method according to claim 1, wherein the one or more failure modes includes a plurality of failure modes, and wherein the output of the machine learning model indicates a probability of process failure via each of the plurality of failure modes.

9. The method according to claim 1, wherein the one or more failure modes include warping, delamination, crack formation, or combinations thereof.

10. The method according to claim 1, comprising dynamically adjusting a process parameter when the probability of process failure via the one or more failure modes in the output of the machine learning model exceeds a threshold value.

11. The method according to claim 1, comprising stopping the surface treatment process or outputting a warning notification when the probability of process failure via the one or more failure modes in the output of the machine learning model exceeds a threshold value, to enable static adjustment of the one or more process parameters to avoid process failure.

12. The method according to claim 1, wherein the training of the machine learning model comprises a baseline training phase based on process data and failure classification labels rendered by physics simulations executed on a plurality of generated process scenarios, followed by a calibration phase comprising a re-training of the machine learning model based on process data and failure classification labels obtained from historical data pertaining to the surface treatment process.

13. The method according to claim 12, wherein the process scenarios are generated based on a design of experiments involving the one or more process parameters.

14. The method according to claim 1, wherein the failure classification labels used in the training of the machine learning model comprise at least one binary variable and/or at least one continuous variable associated with the one or more failure modes.

15. The method according to claim 1, wherein the one or more failure modes includes a plurality of failure modes, and wherein the failure classification labels used in the training of the machine learning model comprises a ranking of the plurality of failure modes.

16. The method according to claim 1, wherein the machine learning model is trained in a cloud computing environment prior to being deployed to the edge computing device.

17. A non-transitory computer-readable storage medium including instructions that, when processed by a computer, configure the computer to perform the method according to claim 1.

18. A system for failure classification of a surface treatment process, comprising:
a sensor module configured to generate sensor data pertaining to measurement of one or more process states pertaining to the surface treatment process,
an edge computing device for controlling the surface treatment process, the edge computing device configured to process a machine learning model which receives, as input, one or more process parameters of the surface treatment process that influence one or more failure modes and the sensor data obtained by measurements during the surface treatment process, to generate an output indicating, in real-time, a probability of process failure via the one or more failure modes,
wherein the machine learning model is trained on a supervised learning regime based on process data and failure classification labels obtained from physics simulations of the surface treatment process in combination with historical data pertaining to the surface treatment process.

19. The system according to claim 18, edge computing device comprises an industrial controller having one or more neural processing unit (NPU) modules configured to process the machine learning model.

20. The system according to claim 18, wherein the sensor module comprises one or more sensors selected from the class of sensors consisting of: an infrared camera, a pyrometer, an acoustic emissions sensor and an accelerometer.
